(19) United States
(12) Patent Application Publication
(10) Pub. No.: US 2011/0193873 A1
(43) Pub. Date: Aug. 11, 2011

(54) DEVICE AND METHOD FOR GENERATING MOSAIC IMAGE INCLUDING TEXT

(75) Inventors: Byung-Jun SON, Seoul (KR); Sung-Dae Cho, Yongin-si (KR); Yun-Jung Kim, Seoul (KR)

(73) Assignee: Samsung Electronics Co., Ltd., Suwon-si (KR)

(21) Appl. No.: 13/013,122

(22) Filed: Jan. 25, 2011

(30) Foreign Application Priority Data
Feb. 8, 2010 (KR) 10-2010-0011498

(51) Int. Cl. G09G 5/00; G09G 5/02; G06K 9/34

(52) U.S. Cl. 345/589; 345/629; 382/164

(57) ABSTRACT

A device and a method for generating a mosaic image including a text is provided. The method includes configuring, upon receiving a request for generating the mosaic image, a mosaic generation screen and displaying the mosaic generation screen; receiving a text input from a user; producing a mosaic unit image that includes the input text; receiving a user-selection of an original image from among at least one original image; and generating the mosaic image for the selected original image.

### PRIORITY

This application claims priority under 35 U.S.C. §119(a) to an application filed in the Korean Industrial Property Office on Feb. 8, 2010, and assigned Serial No. 10-2010-0011498, the contents of which are incorporated herein by reference.

### BACKGROUND OF THE INVENTION

1. Field of the Invention

The present invention relates generally to a device and method for generating a mosaic image, and more particularly, to a device and method for generating a mosaic image using an object that includes a text, such as a letter, a character, or a number.

2. Description of the Related Art

Mosaic images are used in many fields, such as advertising, movies, animation, etc. Non-photorealistic rendering techniques are widely used to generate mosaic images. A non-photorealistic rendering technique includes dividing datum (i.e., an original image) into a plurality of zones, and replacing the divided zones with various tile-form objects, in consideration of correlation with an image characteristic (e.g., as color, edge, texture, etc.) between the objects and the original image.

The non-photorealistic rendering technique requires application of objects possessing various colors and various sizes to the divided zones (i.e., mosaic block). Further, the non-photorealistic rendering technique requires a database for storing the objects of various colors and sizes.

Meanwhile, as portable terminals such as mobile communication terminals have recently become more widely used, many people have been using portable terminals for voice communication and data communication. A portable terminal, which may be utilized for personal use, may be used as a multimedia device that additionally includes various functions, such as a Motion Picture Experts' Group Audio Layer-3 (MP3) player function, a camera function, a video player function, an electronic dictionary function, and a game machine function, in addition to functions for voice data communications. Users also desire to add further additional functions to the portable terminal, such that the portable terminal is a multi-functional device.

In order to meet the users' demands, manufacturers portable terminals are attempting to develop multi-function portable terminals that can be differentiated from portable terminals of other manufacturers. Due to this trend, there have been attempts to apply the conventional methods of generating mosaic images to portable electronic devices like mobile communication terminals.

It is common for portable terminals such as mobile communication terminals to include a memory with a restricted capacity for database. In consideration of the restricted memory capacity of the portable terminal, the mosaic image generation includes storing and using a small amount of objects in the restricted-capacity memory of the portable terminal. More specifically, the conventional portable terminal generates the mosaic image using the objects stored in the memory.

However, because the above-described method for generating a mosaic in a conventional portable terminal relies on using the memory-restricted objects, the ability to reflect characteristics for each the divided zones of the original image is limited, the degree of accuracy in the mosaic image is degraded. Therefore, a mosaic image generated in a portable communication terminal according to the above-described conventional method does not reflect users' expectations.

Further, in order to extract objects having a characteristic most similar to that the characteristics of each of the divided zones of the original image, the conventional mosaic generation method requires many calculations for detecting and comparing an object most similar to the image characteristic, from the memory with the restricted capacity. Accordingly, a long time is required in order for a portable terminal with a low calculation performance to extract the objects having the characteristics most similar to that of the characteristics of each of the divided zones of the original image. As a result, a user may have to wait a long time for the mosaic image to be generated.

In addition, the user may desire to perform mosaic image generation using the original image or an object image relevant to the user, instead of a randomly-collected object image. However, it is difficult to provide mosaic image generation according to this desire while only using various object images according to conventional methods.

### SUMMARY OF THE INVENTION

Accordingly, the present invention has been made to solve the above-mentioned problems occurring in the prior art, and the present invention provides a device and a method for generating a mosaic image, wherein the mosaic image including a user's intention is generated by producing a text-inputted object image and using the produced object image.

According to an aspect of the present invention, a device for generating a mosaic image with text is provided. The device includes a memory for storing at least one original image; a display for displaying a mosaic generation screen; a mosaic processor for producing a mosaic unit image that includes text and applying the produced mosaic unit image to a predetermined zone of an original image selected from among the stored at least one original image to thereby generate the mosaic image for the original image; and, a controller for, upon receiving a request to display the mosaic generation screen, controlling the display to configure the mosaic generation, for controlling the mosaic processor to produce the mosaic unit image if a user inputs the text, and for generating the mosaic image for the selected original image if the user selects one the original image from among the stored at least one original image.

According to another aspect of the present invention, a method for generating a mosaic image is provided. The method includes configuring, upon receiving a request for generating the mosaic image, a mosaic generation screen and displaying the mosaic generation screen; receiving a text input from a user; producing a mosaic unit image that includes the input text; receiving a user-selection of an original image from among at least one original image; and generating the mosaic image for the selected original image.

### BRIEF DESCRIPTION OF THE DRAWINGS

The above and other aspects, features and advantages of the present invention will be more apparent from the following detailed description taken in conjunction with the accompanying drawings, in which:

FIG. 1 is a schematic diagram illustrating a configuration of a device for generating a mosaic image according to an embodiment of the present invention;

FIG. 2 is a screen illustrating a configuration of a display according to an embodiment of the present invention;

FIGS. 3A and 3B are diagrams illustrating text-mapped object images according to an embodiment of the present invention;

FIG. 4A is a flow chart illustrating a process for generating a text-mapped mosaic unit image according to an embodiment of the present invention;

FIG. 4B is a flow chart illustrating a process for generating a mosaic image using a mosaic unit image according to an embodiment of the present invention;

FIG. 5 is a diagram of a mobile terminal illustrating a process for analyzing a characteristic of an original image divided by a block-unit according to an embodiment of the present invention;

FIGS. 6A, 6B, and 6C are diagrams illustrating examples of color-converted mosaic unit images according to an embodiment of the present invention; and

FIGS. 7A, 7B, and 7C are diagrams of a mobile terminal illustrating a mosaic image generated according to an embodiment of the present invention.

### DETAILED DESCRIPTION OF EMBODIMENTS OF THE PRESENT INVENTION

Hereinafter, embodiments of the present invention will be described with reference to the accompanying drawings. In the following description, a detailed description of known functions and configurations incorporated herein may be omitted when such a description may make the subject matter of the present invention unclear.

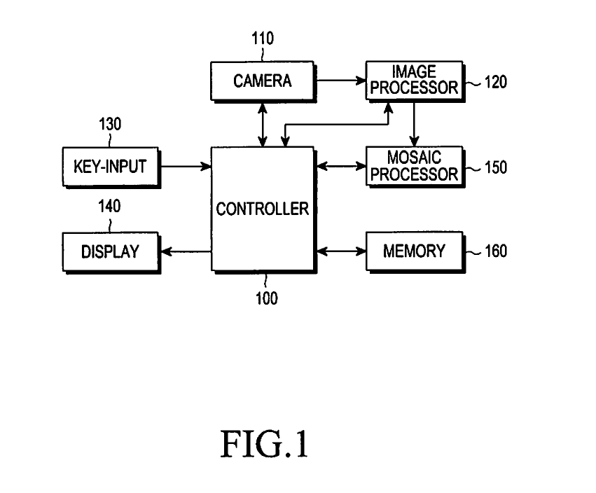

FIG. 1 is a schematic diagram illustrating a configuration of a device for generating a mosaic image according to an embodiment of the present invention.

Referring to FIG. 1, a device for generating the mosaic image according to the embodiment of the present invention includes a controller 100, a camera 110, an image processor 120, a key-input unit 130, a display 140, a mosaic processor 150 and a memory 160.

The controller 100 controls overall operations of the device for generating the mosaic image. More specifically, the controller 100 stores original images output from the camera 110 and the image processor 120, in the memory 160. When a request to generate the mosaic image is provided through the key-input unit 130, the controller 100 controls the display 140 to display a number of object images stored in the memory 160 in order to allow a user to select one of the object images to be used for generating the mosaic image. The term “object image” refers to an image that is used for configuring the mosaic image. The object image is a binary image having a value ranging between 0 and 255. The boundary pixel part of the object image may be configured to have a value brighter than 0 (zero) so as to clearly distinguish between the object images when magnifying the finally generated mosaic image.

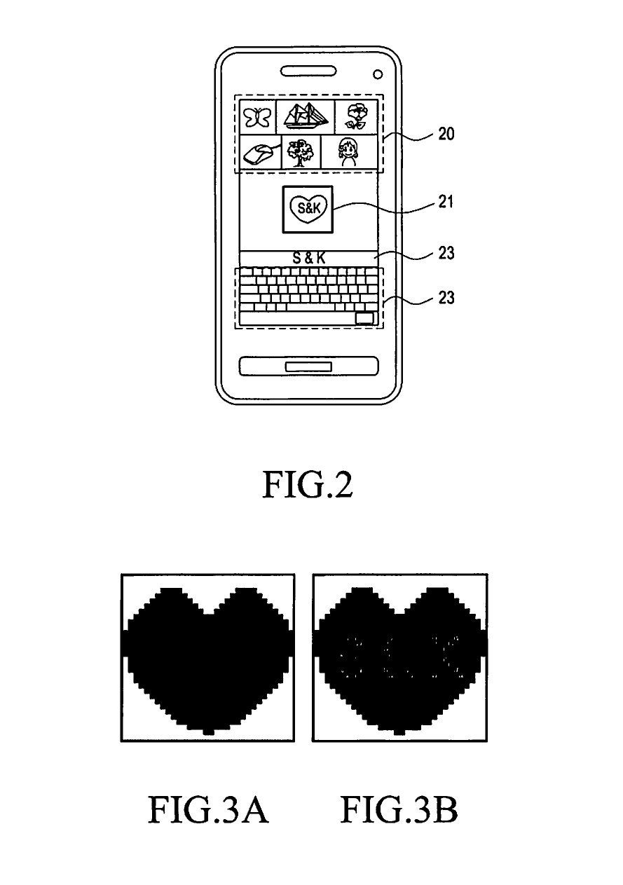

FIG. 2 is a screen illustrating a configuration of a display according to an embodiment of the present invention.

Referring to FIGS. 1 and 2, if the device for generating the mosaic image includes a touch screen for key-input, such as illustrated in FIG. 2, the display 140 may display an object image area 20 for displaying a number of object images; a selected image area 21 for displaying the selected object image; a text area 22 for temporarily displaying text input by the user; and a keyboard area 23 for displaying a keyboard for text input. Otherwise, if the mosaic generation device includes the key input unit 130, the display 140 displays the object image area 20, the selected image area 21 and the text area 22.

Thereafter, if at least one of the object images (e.g., from the object image area 20) is selected through the key-input 130, the controller 100 controls the display 140 to display the selected object image on the selected image area 21. The selected object image may have features such as those illustrated in FIG. 3A, for example.

If a specific text is input through the key-input 130, the controller 100 produces a mosaic unit image that includes the input text, and stores the produced mosaic image in the memory 160. The display 140 displays the input text on the text area 22 at the same time that the input text is displayed on the selected image area 21 by mapping the text at a predetermined position of the object image displayed on the selected image area 21. Here, the produced mosaic unit image may have the features such as those illustrated in FIG. 3B, for example.

If the original image is selected to use for generating the mosaic image, the controller 100 controls the mosaic processor 150 to divide the original image into blocks, each of which has the same size as the above-produced mosaic unit image.

The controller 100 controls the mosaic processor 150 to analyze the image characteristic for each of the blocks of the divided original image and evaluates a color value for each of the blocks. Thereby, the mosaic unit image to be applied to each of the blocks of the divided original image has the same color as that of each block.

In order to address cases where an image corresponding to a specific block has more than two color values, the controller 100 calculates a representative color value for each of the blocks and converts the color value of the mosaic unit image corresponding to each of the blocks into the calculated representative color.

The controller 100 controls the mosaic processor 150 to apply the mosaic unit image to each of the blocks of the original image to thereby generate the mosaic image and then store the generated mosaic image in the memory 160.

The camera 110 performs a general camera function under a control of the controller 100 and takes pictures of objects.

The image processor 120 processes image data from the camera 110 to thereby convert the image data into digital image data of a predetermined format.

The key-input unit 130 includes common keys for inputting text information such as letters, numbers, and characters, and may also include function keys for setting various functions. Particularly, the key-input unit 130 includes a key for selecting the object image used in the generation of the mosaic image and a key for selecting the original image for the generation of the mosaic image. Then, the key-input unit 130 transmits signals corresponding to the keys selected by the user to the controller 100.

The display 140 displays information related to the various operations of the terminal, and, more specifically, the display 140 displays the object image area 20, the selected image area 21, the text area 22 and keyboard area 23 for displaying the keyboard for text-input as shown in FIG. 2.

The mosaic processor 150 produces mosaic unit images, which may include text input through the key-input 130. The mosaic unit image may be produced by mapping the input text to a background image, the size of which is predetermined by the user, or by mapping the input text onto an object image selected by the user from a number of the object images stored in the memory 160.

Thereafter, the mosaic processor 150 divides the selected original image into the blocks, each of which has a size of the mosaic unit image, analyzes the image characteristic for each of the blocks of the divided original image and applies the analyzed image characteristic to the mosaic unit image corresponding to each of the divided blocks.

More specifically, the mosaic processor 150 calculates a representative color value for each of the blocks and converts the color value of the mosaic unit image to be applied to each of the blocks into the same color representative value as the above-calculated representative color value. Thereafter, the mosaic processor 150 applies the mosaic unit image to each of the blocks corresponding to a predetermined area of the original image to thereby generate the mosaic image. The color of the text mapped onto the mosaic unit image is chosen to be different from that the color of the mosaic unit image. For instance, the color of the text may be brighter than that the color of the mosaic unit image or vice versa, such that the text and the mosaic unit image complement each other.

The memory 160 stores a number of the original images and the generated mosaic image. Also, the memory 160 stores a number of object images.

As described herein above, embodiments of the present invention may actively reflect a user's request by generating a mosaic image using a text-mapped object image.

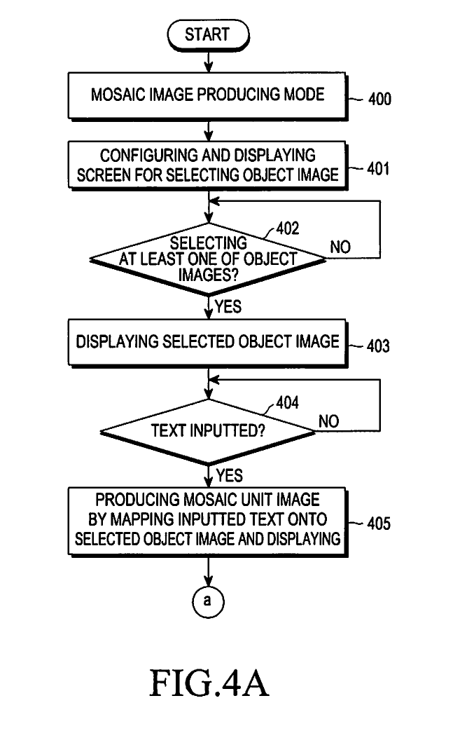

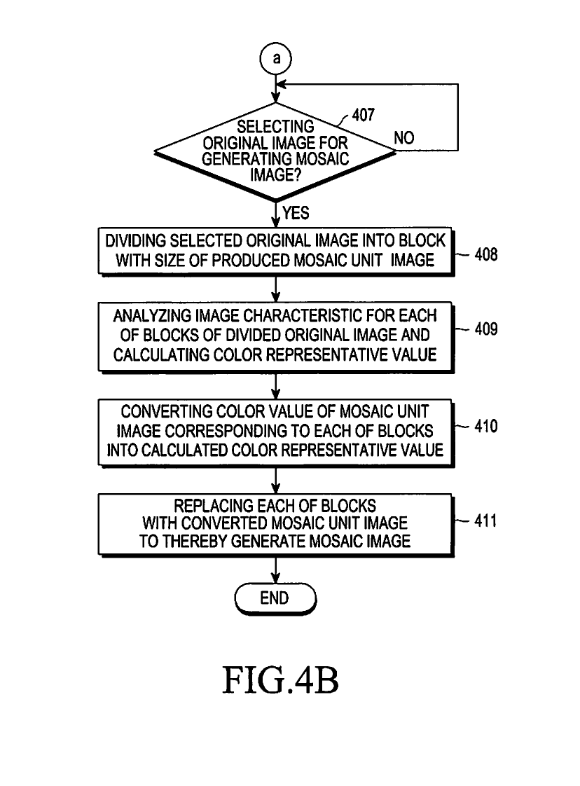

FIGS. 4A and 4B are a flow charts illustrating the process for generating a mosaic image using text in the device for generating the mosaic image according to an embodiment of the present invention. Specifically, FIG. 4A illustrates a process for producing an object image mapped with text selected by the user according to the embodiment of the present invention.

In the embodiment of the present invention described with reference to FIGS. 4A and 4B, it is assumed that several object images have already been stored.

Referring to FIG. 4A, in Step 400, the controller 100 runs in a mosaic image generation mode. Here, the mosaic image generation mode may run when the user inputs a request for generating the mosaic image through the key-input 130.

In step 401, the controller 100 configures a screen for selecting the object image used for generating the mosaic image in accordance with the user's request and displays the same on the display 140. The configured screen may include the object image area 20 for displaying a number of object images, the selected image area 21 for displaying the selected object image, the text area 22 for displaying the text to be mapped onto the selected object image, and the keyboard area 23 for displaying the keyboard for text input.

In step 402, a determination of whether there is any input for selecting at least one of the object images through the key input 130 is performed. Upon determining that an input has been entered, the method proceeds to step 403; otherwise, step 402 is repeated.

In step 403, the controller 100 controls the display 140 to display the selected object image on the selected image area 21 of the display 140.

In step 404, the controller 100 determines whether text is input through key-input 130. If the text is input, the method proceeds to step 405; otherwise, step 404 is repeated.

In step 405, the controller 100 produces the mosaic unit image by mapping the input text onto the selected object image, to thereby display the mosaic unit image on the display 140, and then proceed to Step Q. The mosaic unit image produced as such may be illustrated in FIG. 3B.

FIG. 4B is a flow chart illustrating a process for generating the mosaic image using the mosaic unit image according to an embodiment of the present invention.

Referring to FIG. 4B, in Step 407, which executed after step \textcircled{a} of FIG. 4A, the controller 100 determines whether an original image for generating the mosaic image is selected. If the original image is selected, the method proceeds to step 408; otherwise, step 407 is repeated. Here, the original image may include an image taken by the camera and an image downloaded from a certain download service.

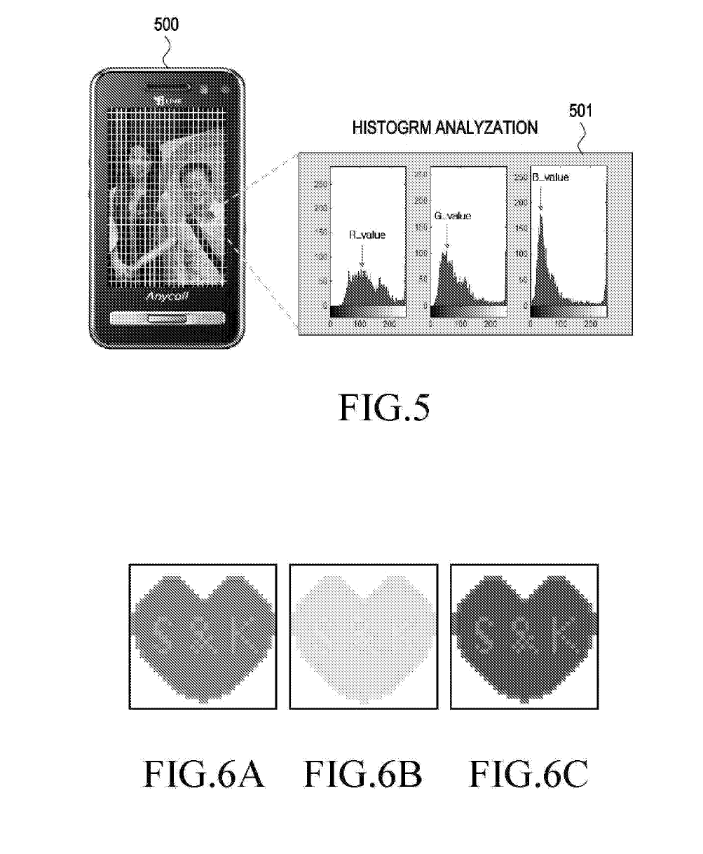

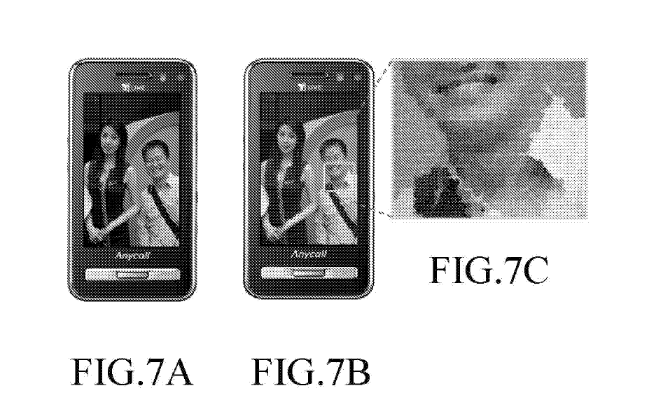

In step 408, the controller 100 controls the mosaic processor 150 to divide the selected original image into a block unit having the same size as the mosaic unit image. The original image divided into the block unit may be an image such as the image denoted by reference numeral 500 in FIG. 5.

In step 409, the controller 100 controls the mosaic processor 150 to analyze the image characteristic for each of the blocks configuring the original image and calculate the representative color value for each of the blocks. More specifically, the mosaic processor 150 analyzes the histogram of R (red), G (green) and B (blue) components for each of the blocks to thereby set up the representative values R_{b}_{_{—}}ᵥₐₗᵤₑ, G_{b}_{_{—}}ᵥₐₗᵤₑ and B_{b}_{_{—}}ᵥₐₗᵤₑ for the R, G, and B components of each of the blocks.

In other words, the mosaic processor 150 calculates maximum values for the R, G, and B components of each block by analyzing the histograms for R, G, and B components denoted with the reference numeral 501 in FIG. 5, and sets up the calculated maximum values for the R, G, and B components as the representative values R_{b}_{_{—}}ᵥₐₗᵤₑ, G_{b}_{_{—}}ᵥₐₗᵤₑ and B_{b}_{_{—}}ᵥₐₗᵤₑ.

In step 410, the mosaic processor 150 converts the color of each mosaic unit image corresponding to each of the blocks into the set-up representative values of R, G, and B components. The mosaic unit images converted may be images such as illustrated in FIGS. 6A, 6B, and 6C, for example.

In step 411, the controller 100 replaces each of the blocks of the divided original image with the color-converted mosaic unit image to thereby generate mosaic image. Then, the mosaic image generation mode ends.

The mosaic processor 150 uses Equation (1) as shown below in order to replace each of the blocks with the mosaic unit image.

$$R\_Block \{ \begin{matrix}Obj\_Model + {R}_{b} \_value & if 0 < Obj\_Model + {R}_{b} \_value < 255 \\ 255 & if 255 < Obj\_Model + {R}_{b} \_value\end{matrix} \} \\ G\_Block \{ \begin{matrix}Obj\_Model + {G}_{b} \_value & if 0 < Obj\_Model + {G}_{b} \_value < 255 \\ 255 & if 255 < Obj\_Model + {G}_{b} \_value\end{matrix} \} \\ B\_Block \{ \begin{matrix}Obj\_Model + {B}_{b} \_value & if 0 < Obj\_Model + {B}_{b} \_value < 255 \\ 255 & if 255 < Obj\_Model + {R}_{b} \_value\end{matrix} \} \qquad ( 1 )$$

Here, Obj_Model indicates the modeled object image. R_Block, G_Block and B_Block indicate the R, G, and B components of the mosaic unit image, respectively. The color values of the mosaic unit image are converted into R_{b}_{_{—}}ᵥₐₗᵤₑ, G_{b}_{_{—}}ᵥₐₗᵤₑ and B_{b}_{_{—}}ᵥₐₗᵤₑ in order to replace each of the divided blocks of the original image. FIGS. 6A, 6B, and 6C illustrate an example wherein the R, G, and B components of the mosaic unit image are converted in their color values. The color of the text may be brighter than a remaining part of the object image excluding the text.

In a device for generating the mosaic image according to an embodiment of the present invention, when the original image illustrated in FIG. 6A is input, the mosaic image illustrated in FIG. 6b is output and the output mosaic image includes the mosaic unit images illustrated in FIG. 6C.

As described herein before, with the generation of the mosaic image using the object image mapped with the user-input text, the present invention enables the user to clearly deliver his/her intention and to generate the mosaic image including what the user intends to express.

With the generation of the mosaic image using the object image, which includes the text reflecting the user's intention, the present invention may reduce a period during which the user waits for completion of the generation of the mosaic image.

While the invention has been shown and described with reference to certain embodiments thereof, it will be understood by those skilled in the art that various changes in form and details may be made therein without departing from the spirit and scope of the invention as defined by the appended claims.

What is claimed is:

1. A device for generating a mosaic image with text, comprising:
a memory for storing at least one original image;
a display for displaying a mosaic generation screen;
a mosaic processor for producing a mosaic unit image that includes text and applying the produced mosaic unit image to a predetermined zone of an original image selected from among the at least one original image to thereby generate the mosaic image for the original image; and
a controller for, upon receiving a request to display the mosaic generation screen, controlling the display to configure the mosaic generation, for controlling the mosaic processor to produce the mosaic unit image if a user inputs the text, and for generating the mosaic image for the selected original image if the user selects the original image from among the stored at least one original image.

2. The device as claimed in claim 1, wherein the mosaic processor produces a background image having a predetermined size and produces the mosaic unit image by mapping the input text to the produced background image.

3. The device as claimed in claim 2, wherein the memory further stores at least one object image, and, if the user selects an object image from the at least one object image, the mosaic processor produces the mosaic unit image by mapping the input text onto the selected object image.

4. The device as claimed in claim 3, wherein the mosaic generation screen includes a text area for displaying the input text.

5. The device as claimed in claim 4, wherein the mosaic generation screen includes an object image area for displaying the at least one stored object image and a selected image area for displaying the selected object image.

6. The device as claimed in claim 5, wherein the mosaic processor divides the selected original image into blocks, such that each block has a same size as a size of the produced mosaic unit image, and analyzes an image characteristic for each of the blocks of the divided original image, to thereby convert a image characteristic of the mosaic unit image corresponding to each of the blocks of the divided original image into a same image characteristic as the analyzed image characteristic.

7. The device as claimed in claim 6, wherein the mosaic processor calculates a representative color value for each of the blocks of the divided original image, and converts a color value of the mosaic unit image to be applied to each of the blocks into a same color value as the calculated representative color value.

8. The device as claimed in claim 7, wherein the mosaic processor sets the color of the text included in the mosaic unit image to be different from the color of the background image.

9. A method for generating a mosaic image including a text, comprising:
configuring, upon receiving a request for generating the mosaic image, a mosaic generation screen and displaying the mosaic generation screen;
receiving a text input from a user;
producing a mosaic unit image that includes the input text;
receiving a user-selection of an original image from among at least one original image; and
generating the mosaic image for the selected original image.

10. The method as claimed in claim 9, wherein producing the mosaic unit image comprises:
producing a background image having a predetermined size; and
mapping the input text onto the produced background image.

11. The method as claimed in claim 10, wherein producing the mosaic unit image further comprises:
receiving a user-selection of an object image from among at least one previously stored object image; and
mapping the input text onto the selected object image.

12. The method as claimed in claim 11, wherein the mosaic generation screen includes a text area for displaying the input text.

13. The method as claimed in claim 12, wherein the mosaic generation screen includes an object image area for displaying the at least one previously stored object image and a selected image display area for displaying the selected object image.

14. The method as claimed in claim 13, wherein generating the mosaic image comprises applying the produced mosaic unit image to a predetermined zone of the selected original image to thereby generate the mosaic image for the original image.

15. The method as claimed in claim 14, wherein generating the mosaic image further comprises:
dividing the selected original image into blocks, each of which has a same size as a size of the produced mosaic unit image;
analyzing an image characteristic for each of the blocks of the divided original image;
converting an image characteristic for the mosaic unit image corresponding to each of the blocks of the divided original image into a same image characteristic as the analyzed image characteristic.

16. The method as claimed in claim 15, wherein analyzing of the image characteristic for each of the blocks of the divided original image comprises calculating a representative color value for each of the blocks of the divided original image.

17. The method as claimed in claim 16, wherein converting the image characteristic for the mosaic unit image corresponding to each of the blocks of the divided original image into the same image characteristic as the analyzed image characteristic comprises converting a color value of mosaic unit image to be applied to each of the blocks into a same color value as the calculated representative color value.

18. The method as claimed in claim 16, wherein a color of the text included in the mosaic unit image is set such that the color of the text included in the mosaic unit image is different from a color of the background image.

19. The method as claimed in claim 17, wherein a color of the text included in the mosaic unit image is set such that the color of the text included in the mosaic unit image is different from a color of the background image.
